(19) United States
(12) Patent Application Publication
(10) Pub. No.: US 2026/0178311 A1
(43) Pub. Date: Jun. 25, 2026

(54) UPDATE INFORMATION NOTIFICATION DEVICE, VEHICLE SYSTEM, AND STORAGE MEDIUM STORING UPDATE INFORMATION NOTIFICATION PROGRAM

(71) Applicant: DENSO CORPORATION, Kariya-city (JP)

(72) Inventors: Koichi TAKAGI, Kariya-city (JP); Toshiaki Horai, Kariya-city (JP); Shiori Maneyama, Kariya-city (JP)

(21) Appl. No.: 19/339,749

(22) Filed: Sep. 25, 2025

Related U.S. Application Data
(63) Continuation of application No. PCT/JP2024/007823, filed on Mar. 1, 2024.

(30) Foreign Application Priority Data
Mar. 29, 2023 (JP) 2023-053438

(51) Int. Cl. G06F 8/65

(52) U.S. Cl. CPC G06F 8/65

(57) ABSTRACT

An update information notification device causes a notification device to provide a notification of update information, acquires the update information, identifies an occupant state indicating a state of an occupant, identifies a vehicle state indicating a state of a vehicle, identifies an operation input, determines a notification mode of the update information and cause the notification device to provide the notification of the update information according to the determined notification mode, and sets the notification mode of the update information to a simpler display mode than when having identified that the occupant is in the vehicle.

### CROSS REFERENCE TO RELATED APPLICATIONS

The present application is a continuation application of International Patent Application No. PCT/JP2024/007823 filed on Mar. 1, 2024, which designated the U.S. and claims the benefit of priority from Japanese Patent Application No. 2023-053438 filed on Mar. 29, 2023. The entire disclosures of all of the above applications are incorporated herein by reference.

### TECHNICAL FIELD

The present disclosure relates to an update information notification device, a vehicle system, and an update information notification program.

### BACKGROUND

For example, a technology for updating software in an in-vehicle electronic control unit (hereinafter referred to as an ECU) has been provided for improving functionality, fixing bugs, and the like. In this system, a server distributes update software to a software update device, and the software update device transmits the update software to the update target ECU. Thereby, the software of the update target ECU is updated. The software update is performed in the following order: a campaign notification phase recommending the software update to the driver; a download phase in which the software update device obtains the update software from the server; an installation phase in which the update target ECU writes the update software to a storage area; and an activation phase in which the update target ECU enables the update software. In this case, update information regarding the software update is displayed on, for example, an in-vehicle display device, a mobile information terminal, or the like to notify the driver, or the like. As a comparative example, a method has been known for notifying a driver or the like of update information related to software updates. In the method, the notification to the driver or the like is differentiated based on the characteristics of the updated software.

### SUMMARY

According to an aspect of the present disclosure, an update information notification device causes a notification device to provide a notification of update information, and includes at least one of (i) a circuit and (ii) a processor with a memory storing computer program code executable by the processor, the at least one of the circuit and the processor configured to cause the update information notification device to: acquire the update information, identify an occupant state indicating a state of an occupant, identify a vehicle state indicating a state of a vehicle, identify an operation input, determine a notification mode of the update information and cause the notification device to provide the notification of the update information according to the determined notification mode, and set the notification mode of the update information to a simpler display mode than when having identified that the occupant is in the vehicle.

### BRIEF DESCRIPTION OF THE DRAWINGS

The above-described features of the present disclosure will become more apparent from the following detailed description with reference to the accompanying drawings.

FIG. 1 is a functional block diagram showing an entire configuration according to an embodiment.

FIG. 2 is a functional block diagram of an HCU.

FIG. 3 is a diagram showing a case classification table.

FIG. 4 is a diagram showing contents of a display mode.

FIG. 5 is a diagram showing the contents of the display mode.

FIG. 6 is a diagram showing the contents of the display mode.

FIG. 7 is a diagram showing the contents of the display mode.

FIG. 8 is a diagram showing the contents of the display mode.

FIG. 9 is a diagram showing the contents of the display mode.

FIG. 10 is a diagram showing a display pattern table.

FIG. 11 is a diagram showing a display pattern.

FIG. 12 is a diagram showing the display pattern.

FIG. 13 is a diagram illustrating display priority.

FIG. 14 is a diagram illustrating operation priority.

FIG. 15 is a diagram illustrating the amount of display information.

FIG. 16 is a flowchart showing a reception determination process for an update information notification signal.

FIG. 17 is a flowchart showing a reception determination process for error information notification signal.

FIG. 18 is a flowchart showing an operation determination process for a simple display request.

FIG. 19 is a diagram illustrating switching to the simple display.

FIG. 20 is a diagram illustrating switching to the simple display.

FIG. 21 is a diagram illustrating switching to the simple display.

FIG. 22 is a diagram illustrating a display of a meter device.

FIG. 23 is a flowchart showing an operation determination process for a detailed display request.

FIG. 24 is a diagram illustrating a display of a reason why switching to detailed display is not possible.

FIG. 25 is a diagram illustrating switching to the detailed display.

FIG. 26 is a flowchart showing an operation determination process for a cancellation request.

FIG. 27 is a diagram illustrating a display of a message indicating the reason for discarding the cancellation request.

FIG. 28 is a diagram illustrating a display of cancellation information.

FIG. 29 is a diagram illustrating a display of cancellation information.

FIG. 30 is a flowchart showing a display request determination process for update information when a vehicle power source is turned.

FIG. 31 is a flowchart showing a vehicle power source-off determination process during a software update.

### DETAILED DESCRIPTION

There are various situations in which software updates are performed, and these can be classified into many situations. For example, notification of update information may be performed while the vehicle is parked. When the notification of the update information is performed while the vehicle is parked, there may be a difficulty that the notification of the update information is performed in a situation where no occupants are present in the vehicle. Even when the notification indicating a large amount of detailed update information is performed, there may be a difficulty that a vehicle battery power is unnecessarily consumed. Due to these circumstances, it is necessary to perform notification indicating update information appropriately according to the situation.

The present disclosure provides a device, a system, and a program that perform appropriate notification of update information related to software updates depending on a situation.

According to an example embodiment of the present disclosure, an update information notification device is configured to cause a notification device to provide a notification of update information related to software update when software of an electronic control unit that is an update target is updated by update software acquired from a distribution device. An update information acquisition unit is configured to acquire the update information. An occupant state identification unit is configured to identify an occupant state indicating a state of an occupant. A vehicle state identification unit is configured to identify a vehicle state indicating a state of a vehicle. An operation input identification unit is configured to identify an operation input by the occupant. A notification control unit is configured to determine a notification mode of the update information and cause the notification device to provide the notification of the update information according to the determined notification mode. In a situation where the vehicle state identification unit has identified that a vehicle power source is off and the occupant state identification unit has identified that the occupant is not present in the vehicle, when the operation input identification unit identifies an operation input indicating a notification request of the update information, the notification control unit sets the notification mode of the update information to a simpler display mode than when the occupant state identification unit has identified that the occupant is in the vehicle.

When the operation input indicating the notification request for update information is identified in a situation where it is identified that the vehicle power source is off and that there is no occupant in the vehicle, the notification mode of the update information is determined more simply than when it is identified that the occupant is in the vehicle. The notification of the update information is performed according to the determined notification mode. By performing the notification of the update information in the simple notification mode with a reduced amount of information, rather than performing the notification of the update information in a detailed notification mode with a large amount of information, the notification of the update information relating to software updates can be appropriately performed according to the situation.

When an operation input is made to request notification of update information when the vehicle power is off and there are no occupants in the vehicle, the notification of the update information is performed in the simpler notification format than when there are occupants in the vehicle. Thereby, it is possible to prevent unnecessary power consumption of the vehicle battery.

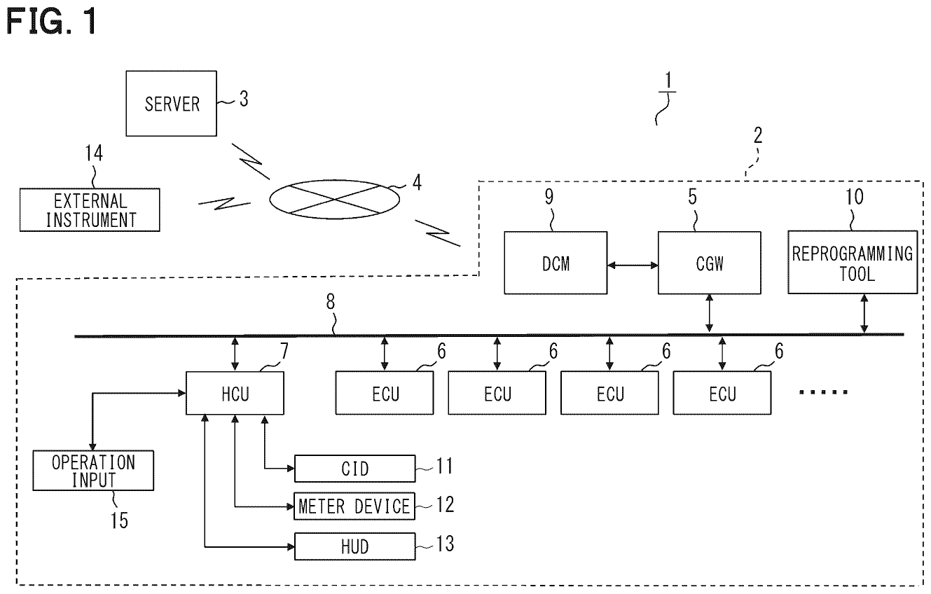

Hereinafter, an embodiment will be described with reference to the drawings. As shown in FIG. 1, a software update system 1 is configured so that a vehicle system 2 installed in a vehicle and a server 3 (corresponding to a distribution device) functioning as an OTA (Over The Air) center can communicate data via a communication network 4. The vehicle system 2 is configured so that a software update device (hereinafter referred to as a central gateway (CGW)) 5 functioning as an OTA master, a number of ECUs 6, and an HMI (Human Machine Interface) control unit 7 (corresponding to an update information notification device) can communicate data via an in-vehicle network 8. The HMI control unit may be also referred to as a HCU 7.

The in-vehicle network 8 is, for example, CAN (Controller Area Network, registered trademark) or the like. The in-vehicle network 8 may be FLEXRAY (registered trademark), CXPI (Clock Extension Peripheral Interface) (registered trademark), Ethernet (registered trademark), or the like. In the present embodiment, a configuration in which four ECUs 6 are connected to the in-vehicle network 8 is shown as an example, but the number of ECUs 6 connected to the in-vehicle network 8 is arbitrary. The number of in-vehicle networks 8 is also arbitrary.

The ECU 6 may be, for example, a device that controls a drive system, a device that controls an ADAS (Advanced Driving Assistant System), or a device that controls a multimedia system, and may be an update target ECU 6 whose software is subject to an update due to software modifications, functional improvements, or the like. The software includes not only so-called programs that instruct a computer on the processing procedures to perform operations, but also files, data, libraries, and the like that are referenced when executing the programs. Depending on a configuration of a software storage area, the ECU 6 can be classified into an ECU having a double-bank memory with two software storage areas, and an ECU having a single-bank memory with one software storage area. A double-bank memory is sometimes called a dual-bank memory. The HCU 7 may also be subject to software updates.

An in-vehicle communication device (hereinafter referred to as a DCM (Data Communication Module)) 9 is connected to the CGW 5. The DCM 9 is wirelessly connected to the server 3 via the communication network 4, thereby becoming capable of receiving update packages distributed from the server 3. The update package distributed from the server 3 includes specification data that can identify the update target ECU 6, and update software that is to be written into the update target ECU 6. The update software corresponds to so-called all data when the software is completely rewritten, and corresponds to so-called difference data when the software is partially rewritten. When the DCM 9 acquires the update package distributed from the server 3, it transfers the acquired update package to the CGW 5.

When an update package is transferred from DCM 9, the CGW 5 extracts the specification data and update software from the transferred update package, identifies the update target ECU 6 from the extracted specification data, transmits the extracted update software to the update target ECU 6, and also transmits an update instruction to the update target ECU 6, and causes the update target ECU 6 to perform the software update. That is, the update target ECU 6 receives the update software and the update instruction from the CGW 5, and writes the update software into the storage area to perform the software update. The manner in which the update software acquired from the server 3 via the communication network 4 is written into the update target ECU 6 is called wireless reprograming. In the present embodiment, a configuration in which the DCM 9 is placed separately from the CGW 5 is exemplified, but the function of the DCM 9 may be incorporated into the CGW 5.

In addition, a reprogramming tool 10 (corresponding to a distribution device) is detachably connected to the in-vehicle network 8. The reprogramming tool 10 distributes update software to the update target ECU 6 while connected to the in-vehicle network 8, and also transmits an update instruction to the update target ECU 6 to cause the update target ECU 6 to update the software. That is, the update target ECU 6 receives the update software and the update instruction from the reprogramming tool 10, and writes the update software into the storage area to perform the software update. The manner in which update software acquired from the reprogramming tool 10 without going through the communication network 4 is written to the update target ECU 6 is called wired reprogramming. In the present embodiment, the configuration in which the reprogramming tool 10 is directly connected to the in-vehicle network 8 is shown as an example, but the reprogramming tool 10 may be connected to the in-vehicle network 8 via the CGW 5.

The software update phases include a campaign notification phase in which the server 3 recommends updating the software to the vehicle system 2, a download phase in which the CGW 5 acquires the update package from the server 3, an installation phase in which the CGW 5 instructs the update target ECU 6 to write the update software to cause the update target ECU 6 to write the update software to the storage area, and an activation phase in which the CGW 5 instructs the ECU 6 to enable the update software to cause the ECU 6 to enable the update software. Each phase progresses as the driver accepts it as appropriate. The CGW 5 manages the software update state in each of these phases of campaign notification, download, installation, and activation, and transmits an update information notification signal indicating the update state to the HCU 7.

The update information is various information related to the software update, and includes information for identifying the progress of the software update, functions that are subject to usage restrictions during the software update, and the like. For example, in a case of the campaign notification phase, the information includes the file name, file size, and function description of the updated software. For example, in a case of the download phase, the information includes information indicating the start of the download, information indicating that a download is in progress, information such as a percentage showing the amount of data that has been downloaded compared to the amount of data that is scheduled to be downloaded as a progress of the download, information for notification of the cancellation reason when the download is cancelled for any reason, and information indicating that the download has been completed, and the like. For example, in a case of the installation phase, the information includes information indicating the start of the installation, information indicating that the installation is in progress, information such as a percentage showing the amount of data that has been installed compared to the amount of data that is scheduled to be installed as a progress of the installation, information for notification of the cancellation reason when the installation is cancelled for any reason, and information indicating that the installation is complete, and the like. For example, in a case of the activation phase, the information includes information indicating the start of activation, information indicating that activation is in progress, information such as a percentage showing the amount of data that has been activated compared to the amount of data that is scheduled to be activated as a progress of activation, information for notification of the cancellation reason when the activation is cancelled for any reason, and information indicating that activation has been completed, and the like. Also, for example, when software related to traveling control is being updated, the information can identify functions that are related to traveling control and subject to usage restrictions.

The CGW 5 transmits an update information notification signal to the HCU 7 at predetermined intervals. Furthermore, when an error occurs during software update, the CGW 5 transmits an error information notification signal to the HCU 7 by way of an interrupt.

The HCU 7 is connected to a center information display (hereinafter referred to as CID) 11 (corresponding to a notification device), a meter device 12 (corresponding to a notification device), and a head-up display (hereinafter referred to as HUD) 13 (corresponding to a notification device). The CID is located in front of the driver's seat and displays, for example, a map used for the navigation function, camera images for the parking assist function, audio information related to the audio, air conditioning information related to the air conditioning, and the like. The meter device 12 is placed in front of the driver's seat and includes various indicators to display vehicle speed, shift position, remaining fuel level, warnings, and the like. The HUD 13 projects information such as vehicle speed, shift position, route guidance, and the like onto a windshield as a virtual image in front of the driver's seat. Furthermore, the external instrument 14 is capable of data communication with the vehicle system 2 by wirelessly connecting to the DCM 9 via the communication network 4. The external instrument 14 is a portable information terminal such as, for example, a smartphone or tablet terminal that can be carried by the occupant and can be used by the occupant outside the vehicle.

When the HCU 7 receives an update information notification signal from the CGW 5 in response to a software update, the HCU 7 can display update information based on the update information notification signal on the CID 11 and the meter device 12. The case where the update information is displayed on the meter device 12 also includes providing a notification indicating the update information by turning on, blinking, or turning off an indicator. In addition, the HCU 7 is wirelessly connected to the external instrument 14 and the DCM 9 via the communication network 4. In a situation where the external instrument 14 and the vehicle system 2 are capable of data communication, when an update information notification signal is received from the CGW 5 in conjunction with a software update, the update information based on the update information notification signal can be displayed on the external instrument 14.

The update information is displayed on the CID 11 and the meter device 12, so that the occupant in the vehicle can check various information related to the software update. Furthermore, by displaying the update information on the external instrument 14 while the occupant is using the external instrument 14 outside the vehicle, the occupant can check various information related to software updates even when outside the vehicle. In the present embodiment, the update information is displayed on the CID 11, the meter device 12, and the external instrument 14. However, the update information may be displayed on the HUD 13 instead.

The HCU 7 is connected to an operation input unit 15 that allows the occupant to input operations. The operation input unit 15 is, for example, a touch panel of the CID 11, a touch panel of the external instrument 14, a steering switch disposed on the steering wheel, or the like. When the operation input unit 15 detects an operation input by the occupant, it transmits an operation input detection signal to the HCU 7. The occupant can input the updated information by operating the operation input unit 15. For example, when a consent screen asking whether to consent to the download is displayed after the campaign notification, the user can input whether to consent to the download. For example, when a consent screen asking whether to consent to the installation is displayed after downloading, the user can input an operation to decide whether to consent to the installation. For example, when a consent screen asking whether to accept activation is displayed after installation, the user can input whether to accept activation.

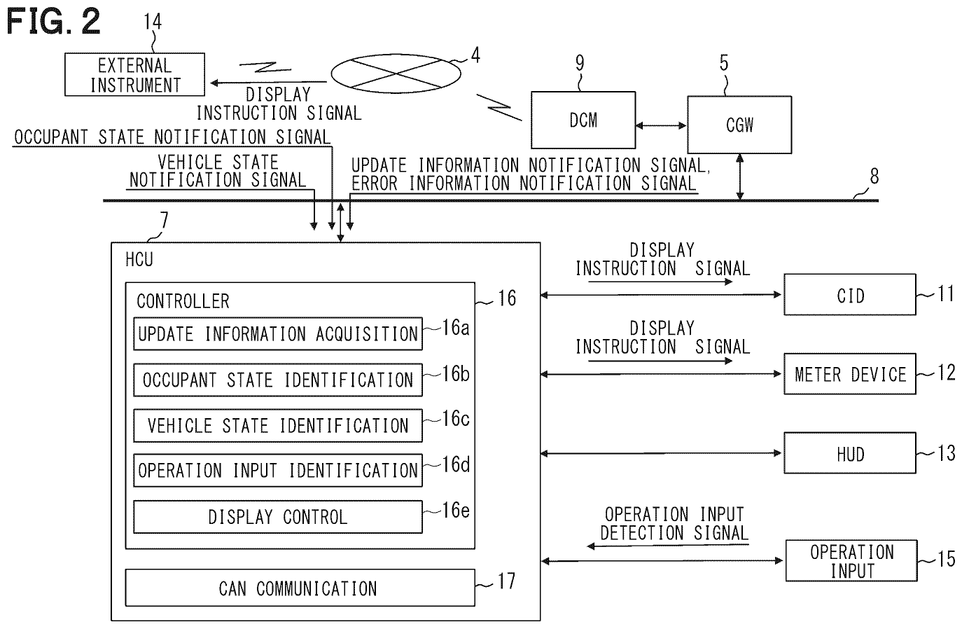

As shown in FIG. 2, the HCU 7 includes a controller16 and a CAN communication unit 17. The controller 16 is provided by a microcomputer having a CPU (i.e., Central Process Unit), a ROM (i.e., Read Only Memory), a RAM (i.e., Random Access Memory), and an I-O (i.e., Input-Output). By executing a control program stored in a non-transitory tangible storage medium, the controller 16 executes a process corresponding to the control program, and controls the overall operation of the HCU 7. The CAN communication unit 17 controls the transmission and reception of CAN signals to and from the in-vehicle network 8. The HCU 7 is connected to a battery power supply (+B) supplied from the vehicle battery, and can operate even when the vehicle power source is off.

The controller 16 includes an update information acquisition unit 16a, an occupant state identification unit 16b, a vehicle state identification unit 16c, an operation input identification unit 16d, and a display control unit 16e (corresponding to a notification control unit). Each of these units 16a to 16e executes an update information notification program.

When the update information acquisition unit 16a receives an update information notification signal from the CGW 5, it acquires update information based on the received update information notification signal.

The occupant state identification unit 16b identifies an occupant state indicating the state of the occupant. When the occupant state identification unit 16b receives an occupant state notification signal indicating, for example, analysis results of an image taken by an image sensor that captures the interior of the vehicle, detection results of a seat sensor that detects seating, detection results of a seat belt sensor that detects whether a seat belt is fastened, or detection results of a biological sensor that detects living organisms, the occupant state identification unit 16b identifies the occupant state based on the received occupant state notification signal. The occupant state identification unit 16b identifies, as the occupant state, for example, whether the occupant is the driver only, whether the occupant is the driver and a passenger, whether the occupant is the passenger only, whether there is no occupant in the vehicle, whether an occupant has gotten in, or whether an occupant has gotten out of the vehicle.

The vehicle state identification unit 16c identifies a vehicle state indicating the state of the vehicle. When the vehicle state identification unit 16c receives the vehicle state notification signal indicating, for example, the on-off state of an ignition signal, the on-off state of an accessory signal, the on-off state of an automated driving function, and the like, it identifies the vehicle state based on the received vehicle state notification signal. The vehicle state identification unit 16c identifies, as the vehicle state, for example, whether the vehicle is traveling, stopped, or parked, whether the vehicle is being driven automatically or manually, and the like. In the present embodiment, an engine vehicle is assumed, and a configuration is exemplified in which it is determined whether the vehicle is traveling or parked based on the on-off state of the ignition signal. However, in the case of an electric vehicle, it may be possible to determine whether the vehicle is traveling or parked based on the on-off state of the EV (Electric Vehicle) system.

The operation input identification unit 16d identifies an operation input by the occupant. When the operation input identification unit 16d receives an operation input detection signal from the operation input unit 15, it identifies the operation input of the occupant based on the received operation input detection signal.

The display control unit 16e determines the display mode of the update information based on the identification results of the occupant state identification unit 16b, the vehicle state identification unit 16c, and the operation input identification unit 16d. That is, the display control unit 16e does not display the update information in a uniform display mode, but displays it in different display modes depending on the occupant state, the vehicle state, and the state of the occupant's operation input. After determining the display mode of the update information, the display control unit 16e transmits a display instruction signal to the CID 11 and the meter device 12, and causes the CID 11 and the meter device 12 to display the update information in accordance with the determined display mode. In addition, when the vehicle system 2 and the external instrument 14 are capable of data communication, the display control unit 16e determines the display mode of the update information, transmits a display instruction signal from the DCM 5 to the external instrument 14, and displays the update information on the external instrument 14 in accordance with the determined display mode.

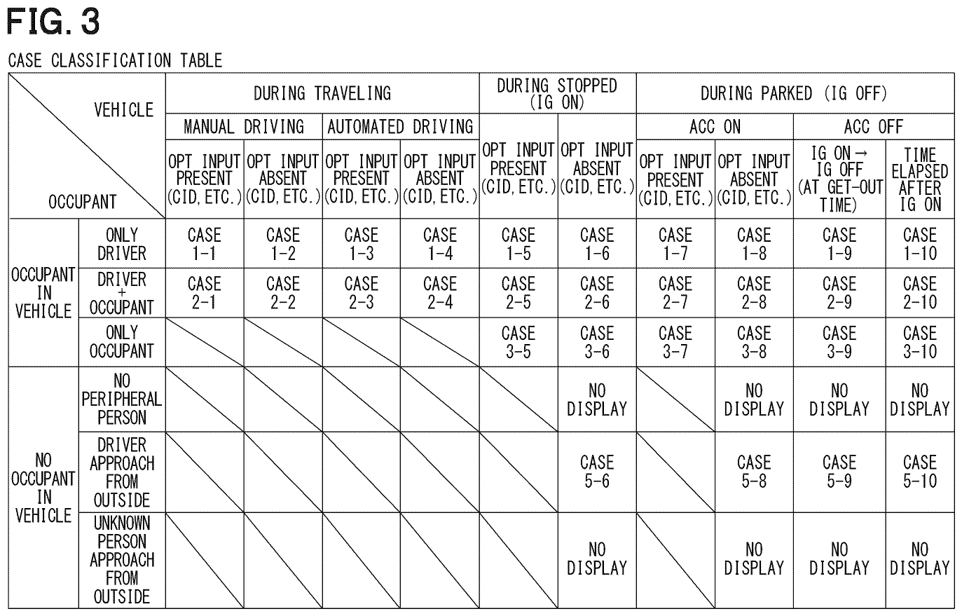

The display mode of update information will be described. As shown in FIG. 3, the display control unit 16e holds a case classification table that classifies cases based on the occupant state, the vehicle state, and the occupant's operation input. The display control unit 16e identifies the appropriate case based on the identification result of the occupant state identification unit 16b, the identification result of the vehicle state identification unit 16c, and the identification result of the operation input identification unit 16d. For example, when the driver is the only occupant in the vehicle, the vehicle is being driven manually, and there is an operation input to the CID 11 or the like, the display control unit 16e identifies case 1-1. Furthermore, the display control unit 16e identifies case 2-10 when, for example, the occupants in the vehicle are the driver and the passenger, the vehicle is parked, the accessories are off, and a predetermined time has passed since the ignition was turned off.

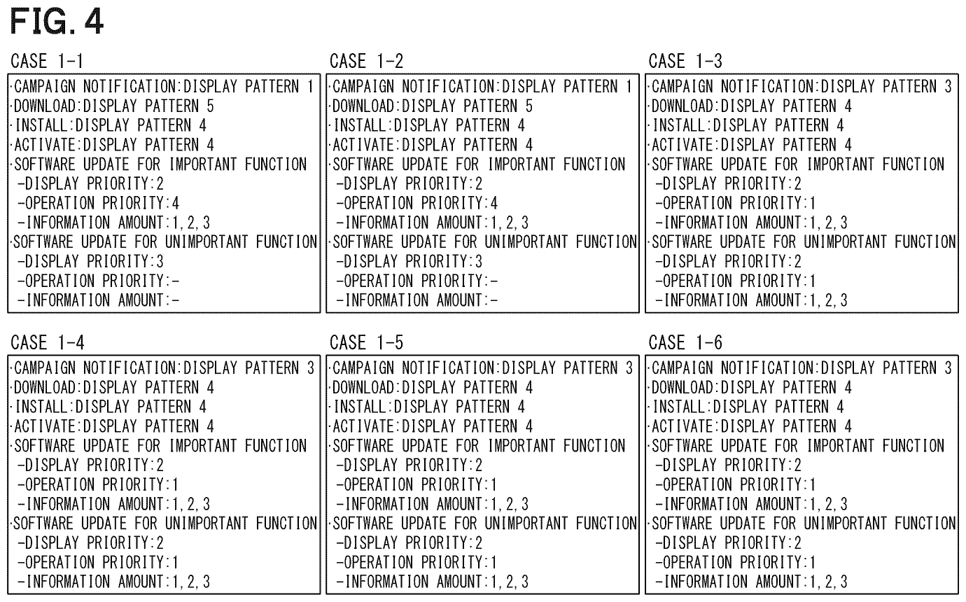

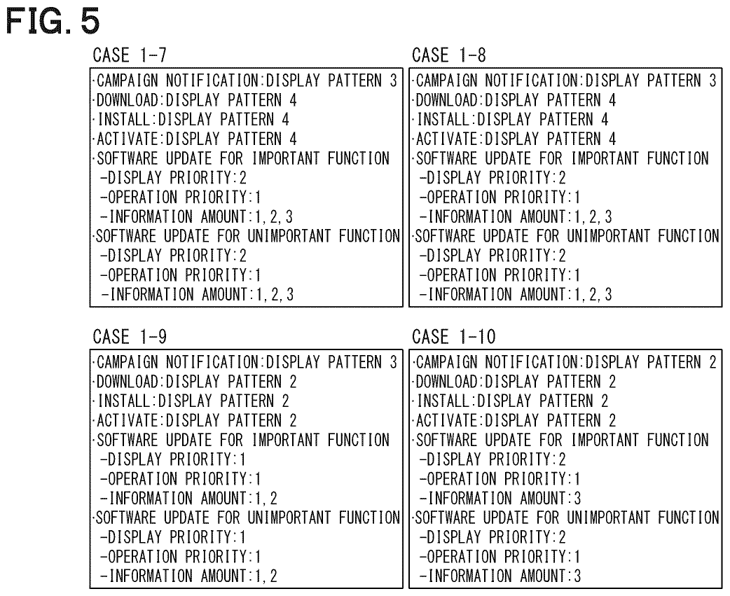

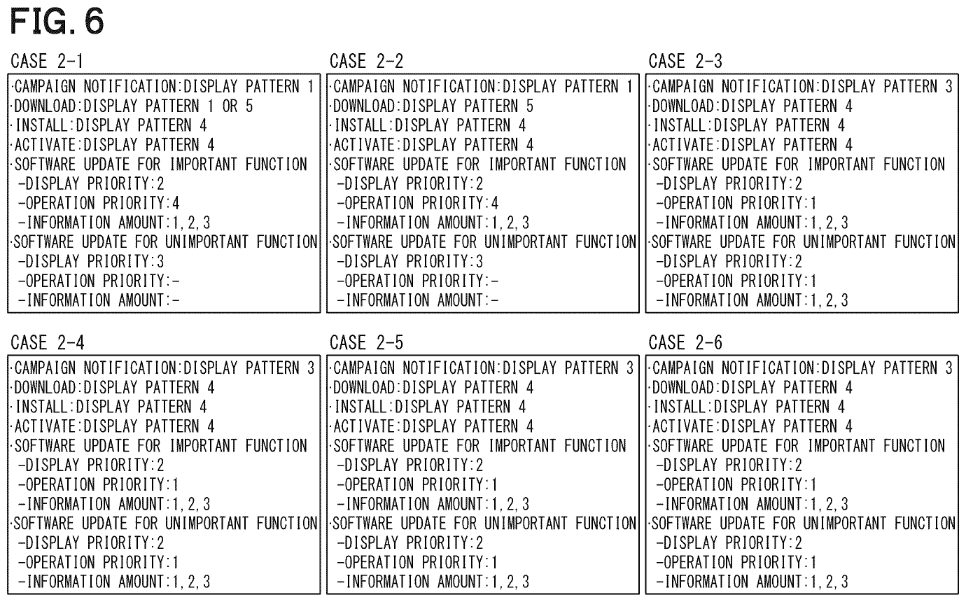

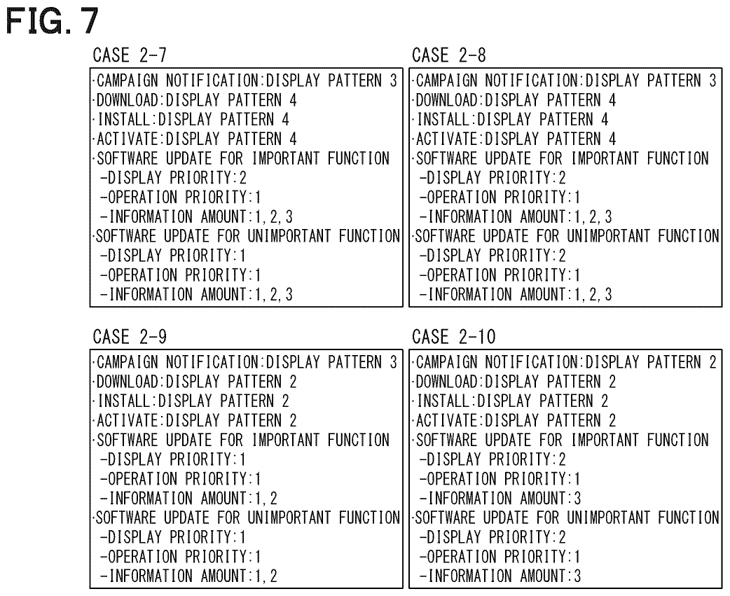

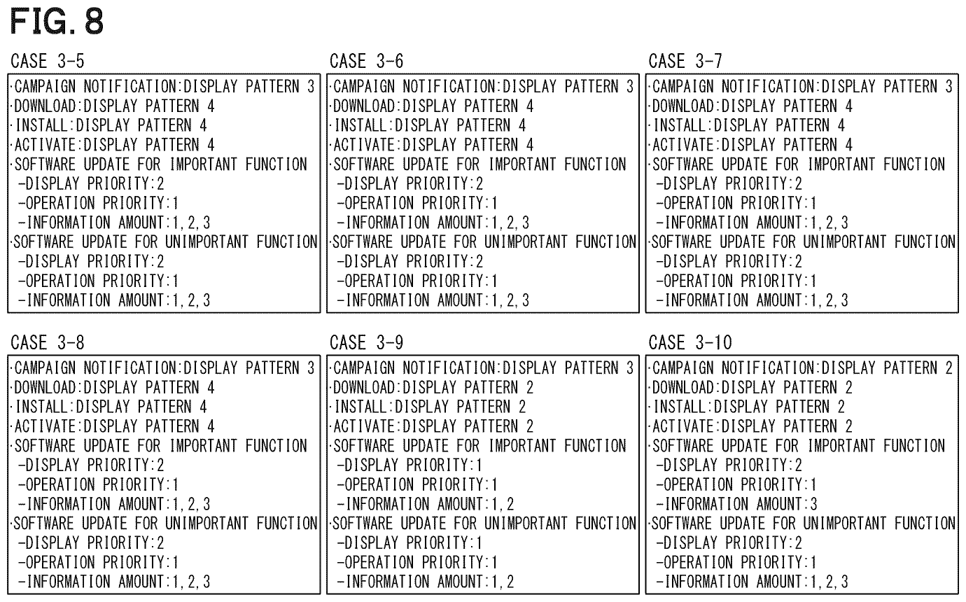

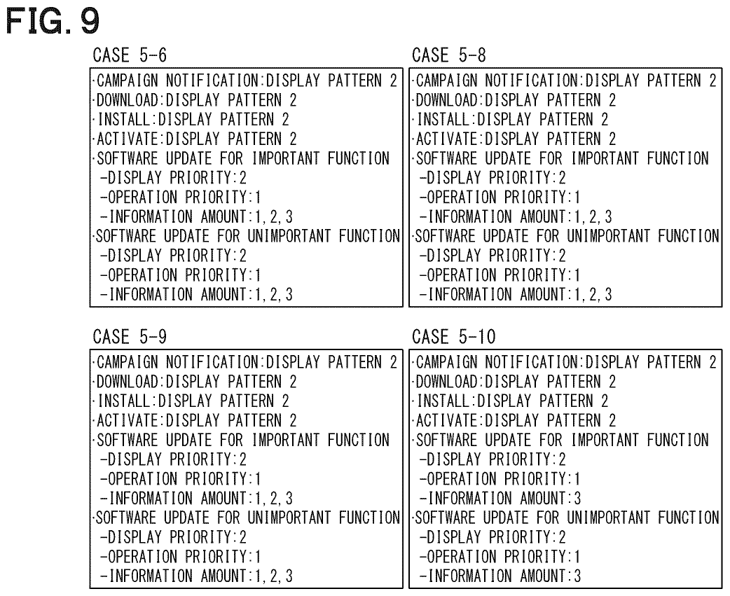

The display control unit 16e defines in advance the content of the display mode of update information for each case classified by the case classification table, as shown in FIGS. 4 to 9. The contents of the display mode of the update information includes: display patterns during campaign notification, download, installation and activation phases; display priority when software update target is the important function; operation priority and amount of display information; display priority when the software update target is the unimportant function; operation priority; and the amount of display information.

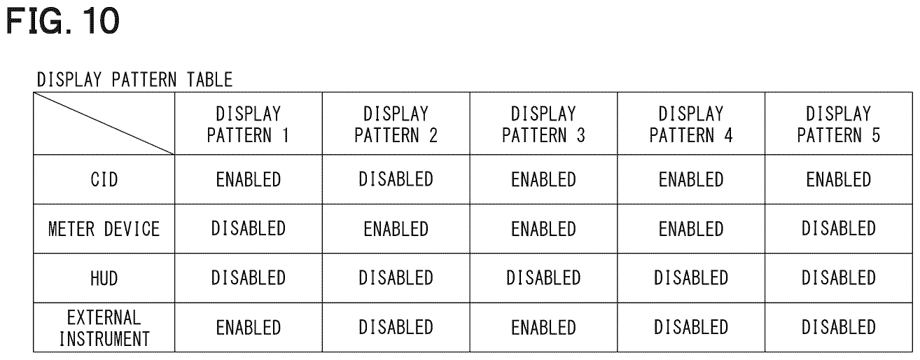

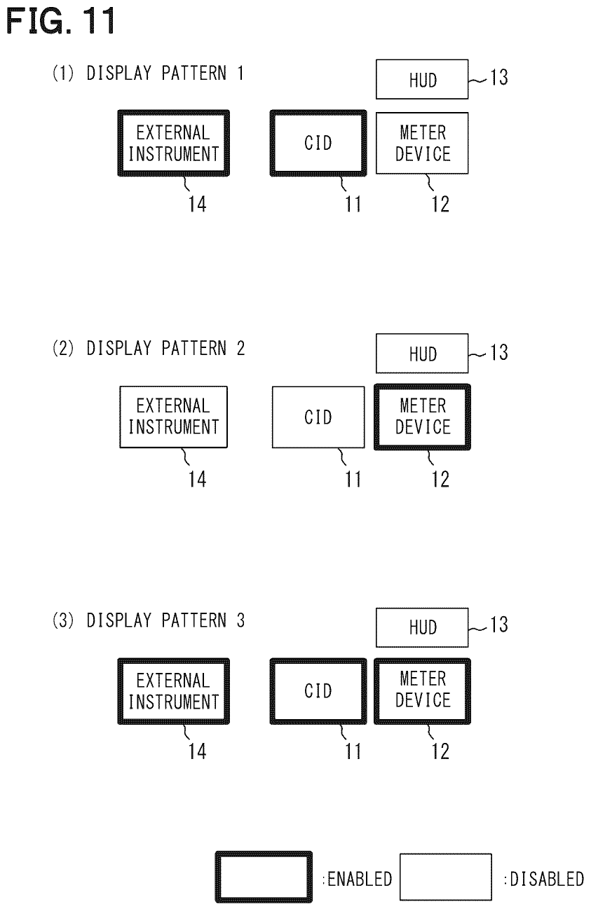

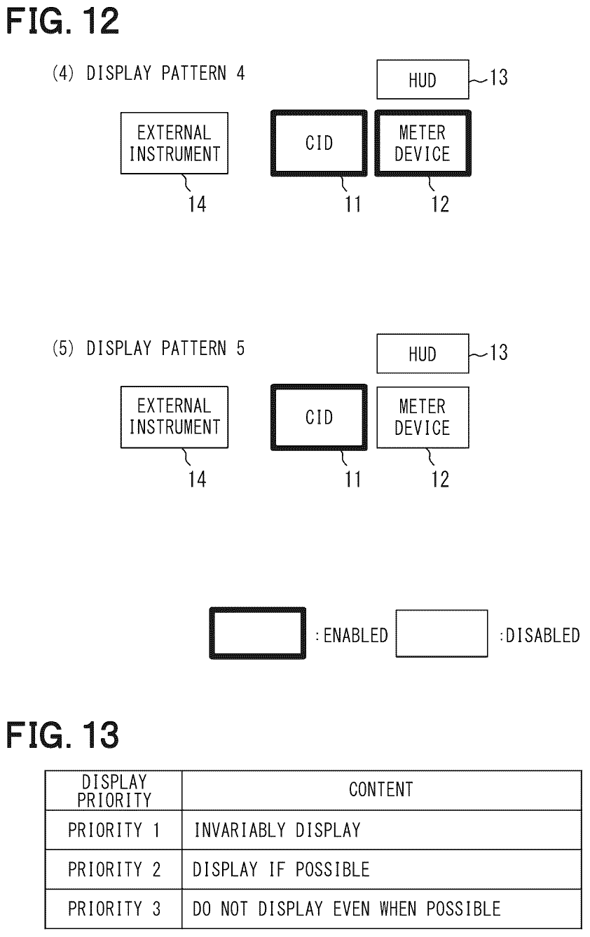

As shown in FIG. 10, the display control unit 16e holds a display pattern table showing display patterns 1 to 5 as display patterns, and sets the corresponding device to either an enabled state or disabled state. As shown in FIGS. 11 and 12, the display patterns 1 to 5 are patterns in which the CID 11, the meter device 12, the HUD 13, and the external instrument 14 are enabled or disabled, respectively. The display control unit 16e causes update information to be displayed on instruments that are set to be enabled, and does not cause update information to be displayed on instruments that are set to be disabled. The display control unit 16e sets multiple devices to be enabled for the display patterns 1, 3, and 4, and therefore when the display pattern 1, 3, or 4 is selected, the update information is displayed on multiple devices.

As shown in FIG. 13, the display control unit 16e sets one of priorities 1 to 3 as the display priority. The priority 1 means “invariably display”, priority 2 means “display if the display is possible”, and priority 3 means “do not display even if the display is possible”.

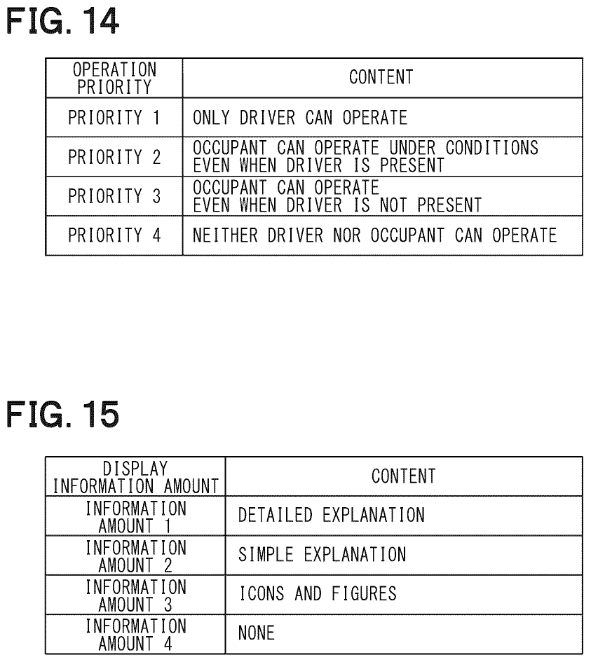

As shown in FIG. 14, the display control unit 16e sets one of priorities 1 to 4 as the operation priority. Priority 1 means “only the driver can operate it”. Priority 2 means “the passenger can operate it under certain conditions even if the driver is present”. Priority 3 means “the passenger can operate it even if the driver is not present (for example, purchased apps and free apps can be used)”. Priority 4 means “neither the driver nor occupant can operate it”.

As shown in FIG. 15, the display control unit 16e sets one of the information amounts 1 to 4 as the amount of display information. The gist of this is that information level 1 is “detailed explanation”, information level 2 is “simple explanation”, information level 3 is “icons and figures”, and information level 4 is “none”.

For example, when identifying case 1-1 where the driver is the only occupant in the vehicle, the vehicle is traveling with manual driving, and there is operational input to the CID 11, and the like, the display control unit 16e selects display pattern 1 in the campaign notification phase to enable the CID 11 and external instrument 14 and disable the meter device 12 and HUD 13. That is, the display control unit 16e causes the CID 11 and the external instrument 14 to display the update information regarding the campaign notification. In the download phase, the display control unit 16e selects the display pattern 5 to enable the CID 11 and disable the meter device 12, the HUD 13, and the external instrument 14. That is, the display control unit 16e causes the CID 11 to display the update information regarding the download. In the installation phase, the display control unit 16e selects the display pattern 4 to enable the CID 11 and the meter device 12 and disable the HUD 13 and the external instrument 14. That is, the display control unit 16e causes the CID 11 and the meter device 12 to display the update information regarding the installation. In the activation phase, the display control unit 16e selects the display pattern 4 to enable the CID 11 and the meter device 12 and disable the HUD 13 and the external instrument 14. That is, the display control unit 16e causes the CID 11 and the meter device 12 to display the update information regarding activation.

Furthermore, when the display control unit 16e identifies, for example, case 1-1, and also when the software update target is the important function, it sets the display priority to the priority 2, the operation priority to the priority 4, and the amount of display information to one of information amounts 1 to 3. Furthermore, for example, when the case 1-1 is identified and also when the software update is for an unimportant function, the display control unit 16e sets the display priority to the priority 3, and does not set the operation priority or the amount of display information.

In this way, the display control unit 16e identifies the relevant case depending on the occupant state, vehicle state, and operation input by the occupant, and displays the update information in a display mode that is predefined for the identified case.

For example, when comparing case 1-1 where the vehicle is traveling with manual driving, with case 1-3 where the vehicle is traveling with automated driving, display pattern 5 is defined for the download phase in case 1-1, and display pattern 4 is defined for case 1-3. This definition is based on a situation that displaying update information on the meter device 12 during the vehicle traveling with manual driving may interfere with the driver's driving operations, but displaying update information on the meter device 12 during the vehicle traveling with automated driving will not cause any difficulties.

Similarly, when comparing case 1-1 and case 1-3, for example, the operational priority of software update for important functions is defined as priority 4 in case 1-1 and the priority 1 in case 1-3. This definition is based on the situation that allowing operations during the vehicle traveling with the manual driving could interfere with the driver's driving operations, but allowing operations during the vehicle traveling with automated driving will not cause any difficulties.

For example, when comparing case 1-1 where the vehicle is traveling with manual driving with case 1-9 where the vehicle is parked and the driver gets out, the display priority for software updates of important functions is defined as the priority 2 in case 1-1 and priority 1 in case 1-9. This definition is intended to mean that display of updated information is not essential when the vehicle is traveling with manual driving, but is essential when the driver gets out of the parked vehicle.

For example, when comparing case 1-1 where the vehicle is traveling with manual driving with case 1-5 where the vehicle is stopped, the amount of display information for software updates of unimportant functions may not be defined in case 1-1, but the priorities 1, 2, and 3 may be defined in case 1-5. This definition is based on the fact that, while increasing the amount of information provided during the vehicle traveling with manual driving may interfere with the driver's driving operations, the increase in the amount of information provided during stop of the vehicle will not cause any difficulties.

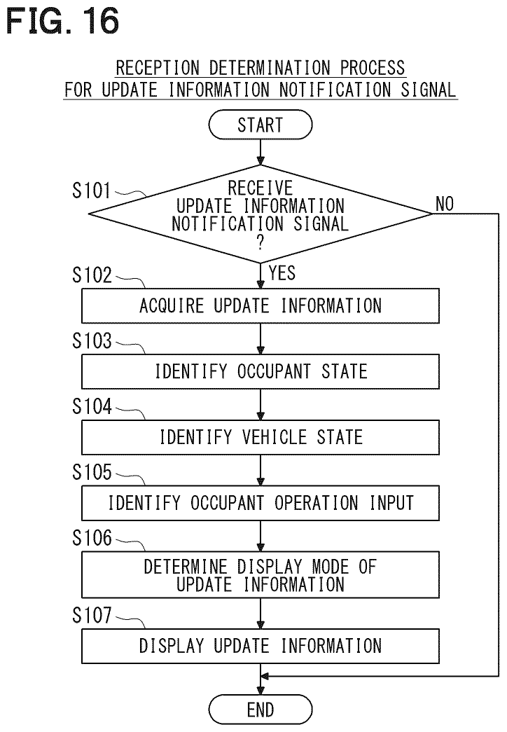

Next, the operation of the above-described configuration will be described with reference to FIGS. 16 to 31. Here, the process of determining the display mode of update information based on the results of identifying the occupant state and the vehicle state, the process of determining the display mode of update information based on the results of identifying the operation input, and the process of displaying update information when the vehicle power source is off, will be described in order.

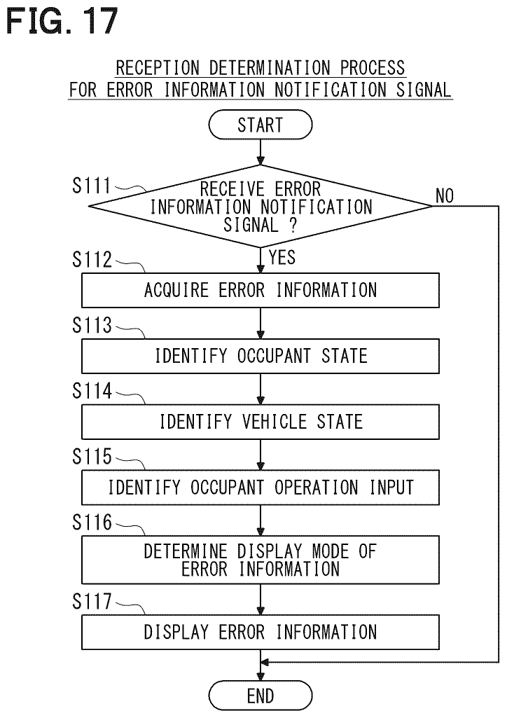

### (1) Process for Determining Display Mode of Update Information Based on Results of Identifying Occupant State and Vehicle State (See FIGS. 16 and 17)

Here, the reception determination process for the update information notification signal and the reception determination process for the error information notification signal will be described in order.

### (1-1) Reception Determination Process for Update Information Notification Signal (See FIG. 16)

The controller 16 executes a reception determination process for the update information notification signal at a predetermined interval. When the controller 16 starts the reception determination process for the update information notification signal, the controller 16 determines whether the update information notification signal has been received from the CGW 5 (S101). When the controller 16 determines that the update information notification signal has not been received (NO in S101), the controller 16 ends the reception determination process for the update information notification signal.

When the controller 16 determines that the update information notification signal has been received (YES in S101), it acquires update information based on the received update information notification signal (S102, corresponding to an update information acquisition procedure). The controller 16 determines the occupant state based on the occupant state notification signal (S103, corresponding to an occupant state determination procedure). The controller 16 identifies the vehicle state based on the vehicle state notification signal (S104, corresponding to a vehicle state identification procedure). The controller 16 identifies the operation input by the occupant based on the operation input detection signal (S105, corresponding to an operation input identification procedure).

The controller 16 determines the display mode of the update information based on the result of identifying the occupant state, the result of identifying the vehicle state, and the result of identifying the occupant's operation input (S106, corresponding to a notification mode determination procedure). That is, the controller 16 refers to the case classification table shown in FIG. 3 and selects the appropriate case. When the controller 16 selects the appropriate case, it sends a display instruction signal to the appropriate instrument according to the selected case, causes the update information to be displayed on the appropriate device (S107, corresponding to a notification control procedure), and ends the reception determination process for the update information notification signal.

The controller 16 identifies case 1-1 by using the case classification table shown in FIG. 3, for example, when it identifies a result of “driver only” as the result of identifying the occupant state, identifies a result that “the vehicle is traveling with manual driving” as the result of identifying the vehicle state, and identifies a result that “the operation input is present” as the result of identifying the occupant operation input. In the drawings, the operation input may be referred to as “OPT INPUT”. According to the display mode of case 1-1 shown in FIG. 4, for example, in the campaign notification phase, the controller 16 selects the display pattern 1, and causes the CID 11 and external instrument 14 to display the update information regarding the campaign notification. That is, the driver can check the update information regarding the campaign notification through the CID 11 and the external instrument 14.

When the campaign notification phase shifts to the download phase, the controller 16 selects the display pattern 5 and causes the CID 11 to display update information regarding downloading. That is, the driver can check the update information regarding the download by CID 11. When the download phase shifts to the installation phase, the controller 16 selects the display pattern 4 and causes the CID 11 and the meter device 12 to display update information related to the installation. That is, the driver can check the update information regarding the installation by using the CID 11 and the meter device 12. When the phase shifts from the installation phase to the activation phase, the controller 16 continues to select the display pattern 4, and causes the CID 11 and the meter device 12 to display the update information regarding activation. That is, the driver can check the update information regarding activation through the CID 11 and the meter device 12.

The above is an example of continuing case 1-1 from the campaign notification phase to the activation phase. However, when the controller 16 identifies a change in the occupant state, vehicle state, or occupant operation input between the campaign notification phase and the activation phase, it selects a new case that corresponds to the change. The controller 16 transmits a display instruction signal to the relevant instrument in accordance with the selected new case, and causes the relevant instrument to display the update information. For example, the controller 16 identifies a new case 1-5 when it identifies a result of “driver only” as the result of identifying the occupant state, identifies a result that “the vehicle is being stopped” as the result of identifying the vehicle state, and identifies a result that “the operation input is present” as the result of identifying the occupant operation input. The controller 16 causes the appropriate instrument to display the update information in a display mode corresponding to case 1-5 shown in FIG. 4. That is, the controller 16 switches from case 1-1 to case 1-5 and causes the appropriate instrument to display the update information.

### (1-2) Reception Determination Process for Error Information Notification Signal (See FIG. 17)

The controller 16 executes the reception determination process for the error information notification signal at the predetermined interval. When starting the reception determination process for the error information notification signal, the controller 16 determines whether the error information notification signal has been received from the CGW 5 (S111). When determining that the error information notification signal has not been received (NO in S111), the controller 16 ends the reception determination process for the error information notification signal.

When determining that the error information notification signal has been received (YES in S111), the controller 16 acquires error information based on the received error information notification signal (S112). The controller 16 identifies the occupant state based on the occupant state notification signal (S113). The controller 16 identifies the vehicle state based on the vehicle state notification signal (S114). The controller 16 identifies the operation input by the occupant based on the operation input detection signal (S115).

The controller 16 determines the display mode of the error information based on the results of identifying the occupant state, the results of identifying the vehicle state, and the results of identifying the operation input by the occupant (S116). That is, the controller 16 refers to the case classification table shown in FIG. 3 and selects the appropriate case. When selecting the appropriate case, the controller 16 transmits a display instruction signal to the appropriate instrument according to the selected case, causes the appropriate instrument to display the error information (S117), and ends the reception determination process for the error information notification signal.

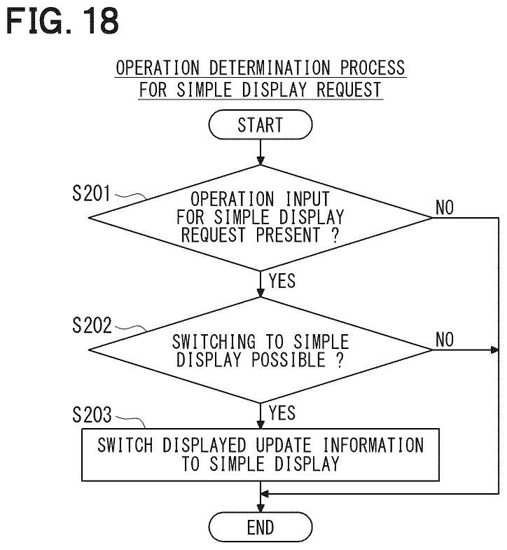

### (2) Process for Determining Display Mode of Update Information Based on Identification Result of Operation Input (See FIGS. 18 to 29)

Here, the operation determination process for the simple display request, the operation determination process for the detailed display request, and the operation determination process for the cancellation request will be described in order.

### (2-1) Operation Determination Process for Simple Display Request (See FIGS. 18 to 22)

For example, the driver who desires the simple display of update information performs an operation input requesting the simple display. The controller 16 executes the operation determination process for the simple display request at the predetermined interval while displaying the update information. When starting the operation determination process for the simple display request, the controller 16 determines whether the operation input for the simple display request has occurred based on the operation input detection signal from the operation input unit 15 (S201). When the controller 16 determines that no operation input for the simple display request has occurred (NO in S201), the controller 16 ends the operation determination process for the simple display request.

When the controller 16 determines that the operation input for requesting simple display has occurred (YES in S201), the controller 16 determines whether the currently displayed update information can be switched to the simple display (S202). When the controller 16 determines that the currently displayed update information cannot be switched to the simple display (NO in S202), the controller 16 does not switch the currently displayed update information to the simple display, and ends the simple display request operation determination process. When the controller 16 determines that the currently displayed update information can be switched to the simple display (YES in S202), the controller 16 switches the currently displayed update information to the simple display (S203) and ends the operation determination process for the simple display request.

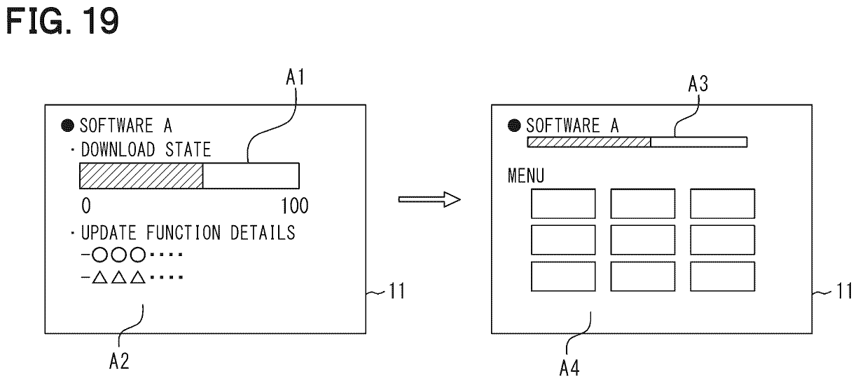

As shown in FIG. 19, when the controller 16 determines that the switching to the simple display is possible while displaying the update information, such as, for example, a progress bar A1 indicating the download state and a function description A2 as details of the update function on CID 11, the controller 16 performs switching to a screen that displays only a progress bar A3 as the update information and a menu button group A4 as information unrelated to the update information. The information unrelated to the update information may be other than the menu button group A4, such as, for example, a map used for the navigation function, camera images from the parking assist function, audio information related to audio, air conditioning information related to air conditioning, and the like.

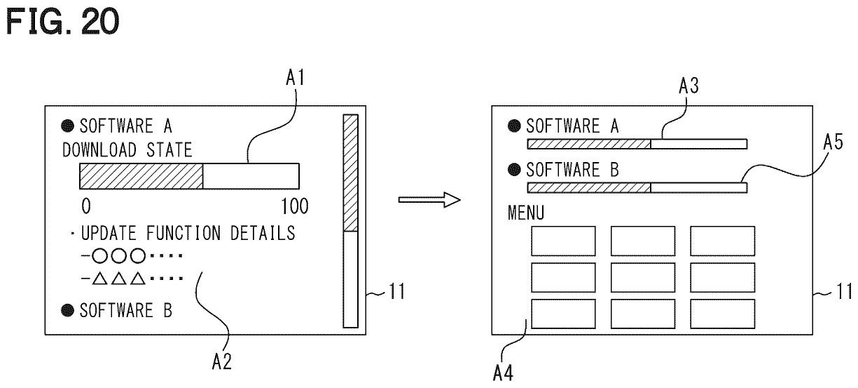

Similarly, as shown in FIG. 20, when there are multiple software updates, the controller 16 displays only progress bars A3 and A5 as update information for each software update and performs switching to a screen that displays the menu button group A4.

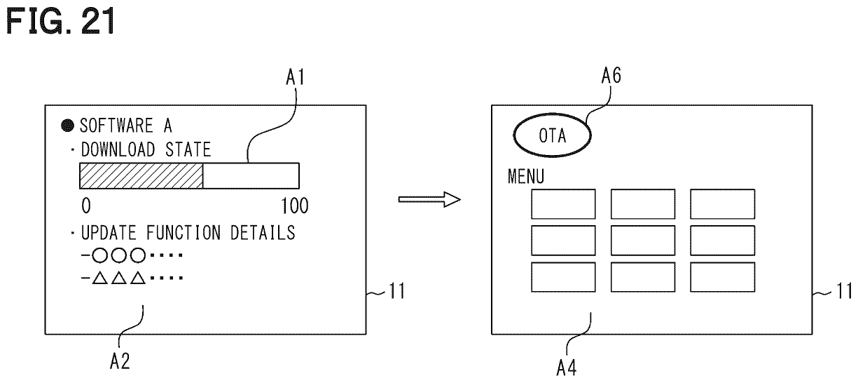

As shown in FIG. 21, the controller 16 may also perform switching to a screen that displays an updating button A6 as update information in a flashing manner instead of the progress bar A3, and also displays the menu button group A4.

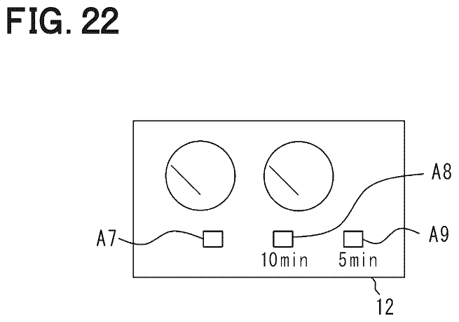

Furthermore, as shown in FIG. 22, the controller 16 may cause the meter device 12 to display indicators A7 to A9, and may cause indicators A8 and A9 according to the functions for which software is being updated to display the remaining time until the software update is completed.

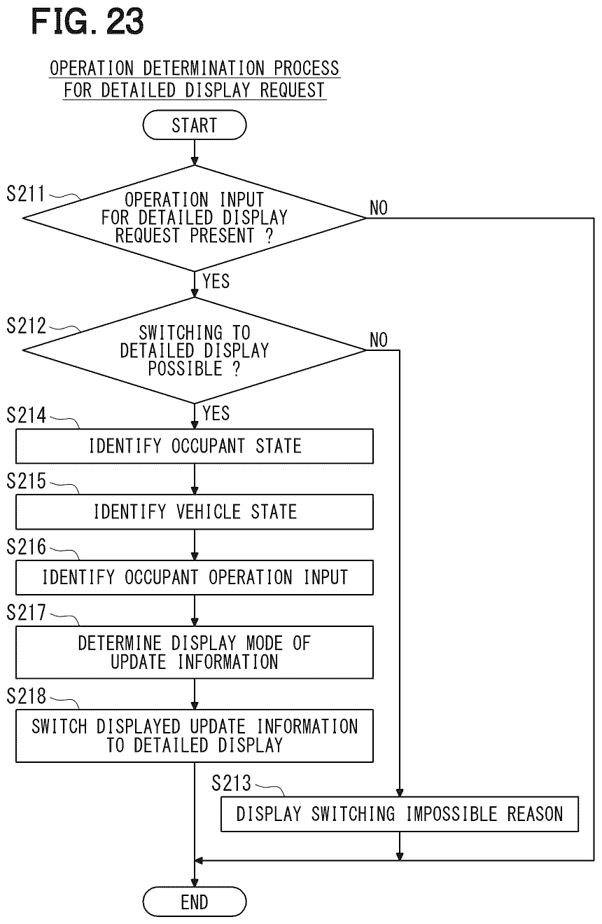

### (2-2) Operation Determination Process for Detailed Display Request (See FIGS. 23 to 25)

For example, a driver who desires to display detailed update information performs the operation input for the detailed display request. The controller 16 executes the operation determination process for the detailed display request at the predetermined interval while displaying the update information. When the controller 16 starts the operation determination process for the detail display request, it determines whether the operation input for the detail display request has occurred based on the operation input detection signal from the operation input unit 15 (S211). When the controller 16 determines that no operation input for the detailed display request has been made (NO in S211), the controller 16 ends the operation determination process for the detailed display request.

When determining that the operation input for the detailed display request has occurred (YES in S211), the controller 16 determines whether the currently displayed updated information can be switched to the detailed display (S212). When determining that the displayed update information cannot be switched to detailed display (NO in S212), the controller 16 does not switch the displayed update information to detailed display, but displays a message indicating the reason why switching to detailed display is not possible (S213), and ends the operation determination process for the detailed display request.

When determining that the display of the updated information can be switched to detailed display (YES in S212), the controller 16 identifies the occupant state based on the occupant state notification signal (S214), identifies the vehicle state based on the vehicle state notification signal (S215), identifies the operation input of the occupant based on the operation input detection signal (S216), and determines the display mode of the update information based on the results of identifying the occupant state, the results of identifying the vehicle state, and the results of identifying the operation input by the occupant (S217). The controller 16 switches the currently displayed update information to the detailed display in accordance with the determined display mode (S218), and ends the operation determination process for the detailed display request.

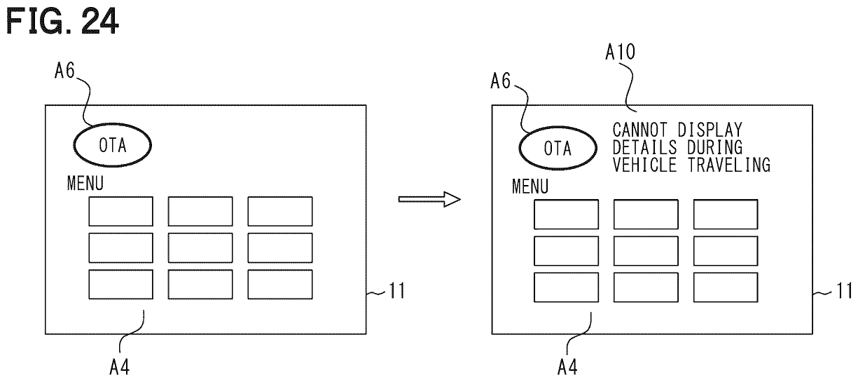

As shown in FIG. 24, when determining that the switching to detailed display is not possible while displaying the updating button A6 as update information and the menu button group A4 on CID 11, the controller 16 does not switch the displayed update information to detailed display, but displays a message A10 indicating the reason why switching to detailed display is not possible: “Cannot display details during vehicle traveling”.

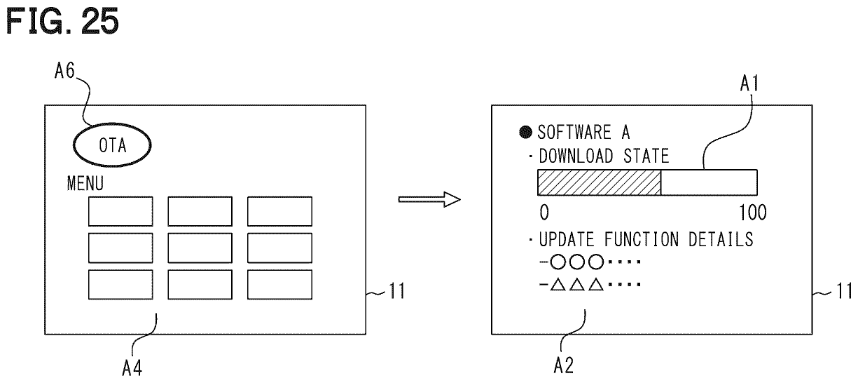

As shown in FIG. 25, when determining that switching to the detailed display is possible while the updating button A6 is displayed as update information and the menu button group A4 is displayed on CID 11, the controller 16 performs switching to a screen that displays, as update information, for example, the progress bar A1 as the download state and the function description A2 as update function details.

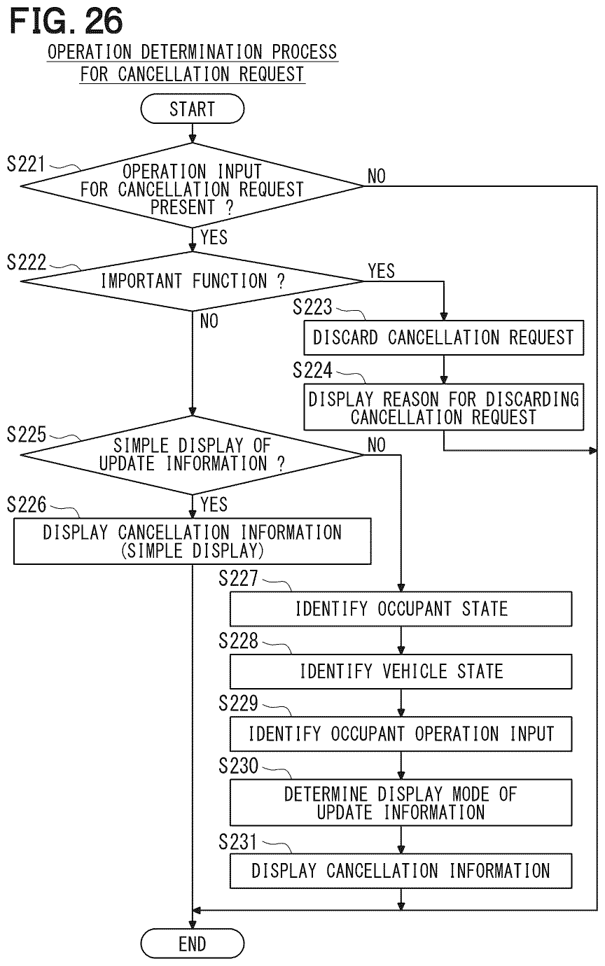

### (2-3) Operation Determination Process for Cancellation Request (See FIGS. 26 to 29)

For example, the driver who desires to cancel the software update performs an operation input of the cancellation request. The controller 16 executes an operation determination for the cancellation request at the predetermined interval while update information is being displayed. When starting the operation determination process for the stop request, the controller 16 determines whether the operation input for the cancellation request has occurred based on the operation input detection signal from the operation input unit 15 (S221). When determining that the operation input for the cancellation request has not occurred (NO in S221), the controller 16 ends the operation determination process for the cancellation request.

When determining that the operation input for the cancellation request has occurred (YES in S221), the controller 16 determines whether the target of the cancellation request is the important function (S222). When the controller 16 determines that an operation input for requesting cancellation has occurred (YES in S221), the controller 16 determines whether the software update for which the cancellation request is for the important function (S222).

When the controller 16 determines that the software update requested for the cancellation is for the important function (YES in S222), the controller 16 discards the cancellation request (S223). The controller 16 displays a message indicating the reason for discarding the cancellation request (S224), and ends the operation determination process for the cancellation request.

When determining that the software update target requested for cancellation is not for the important function (NO in S222), the controller 16 determines whether the update information is being displayed in the simple display manner (S225). When determining that the update information is being displayed in the simple display manner (YES in S225), the controller 16 causes the appropriate instrument to display cancellation information indicating that the software update has been cancelled (S226), and ends the operation determination process for the cancellation request.

When determining that the updated information is not being displayed in the simple display manner (NO in S225), the controller 16 identifies the occupant state based on the occupant state notification signal (S227), identifies the vehicle state based on the vehicle state notification signal (S228), identifies the operation input of the occupant based on the operation input detection signal (S229), and determines the display mode of the update information based on the results of identifying the occupant state, the results of identifying the vehicle state, and the results of identifying the operation input by the occupant (S230). The controller 16 displays the cancellation information indicating the cancellation of the software update on the appropriate instrument in accordance with the determined display mode (S231), and ends the operation determination process for the cancellation request. In this case, the controller 16 displays the cancellation information in detail when the detailed display is possible based on the identification result of the occupant state, the identification result of the vehicle state, and the identification result of the operation input by the occupant. When the detailed display is not possible, the cancellation information is displayed simply.

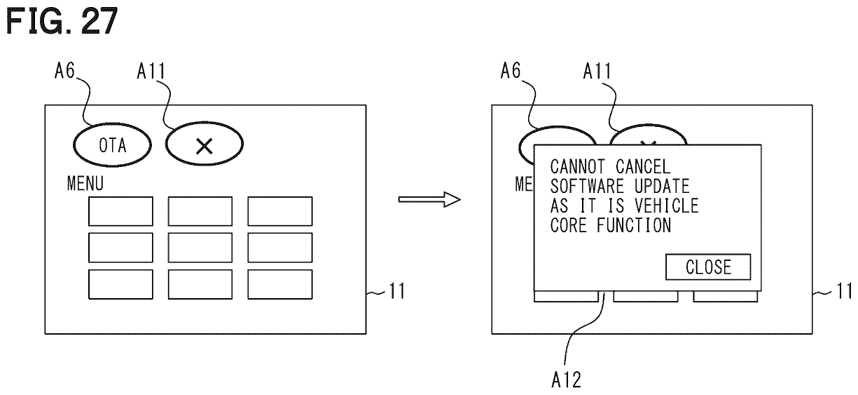

As shown in FIG. 27, the controller 16 determines that, for example, an operation input of cancellation button A11 has occurred. When determining that the software update target of the cancellation request is the important function, the controller discards the cancellation request. The controller 16 displays a message A12 indicating the reason for discarding the cancellation request: “Cannot cancel software update as it is a vehicle core function”.

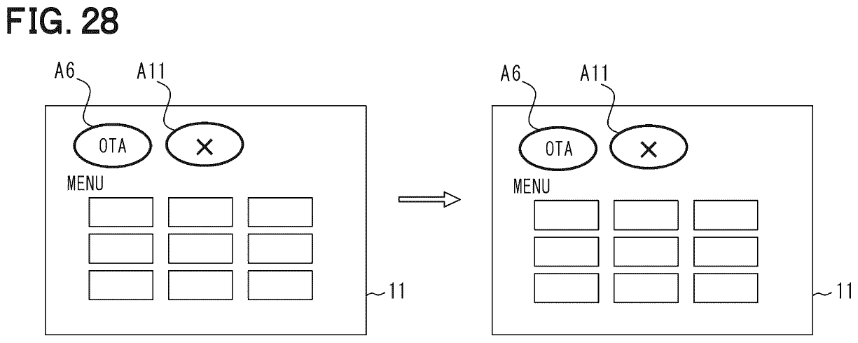

As shown in FIG. 28, when determining that the update information is being displayed in the simple display manner, the controller 16 causes the appropriate instrument to display cancellation information indicating cancellation of the software update. The controller 16 displays the cancellation information by, for example, graying out the updating button A6.

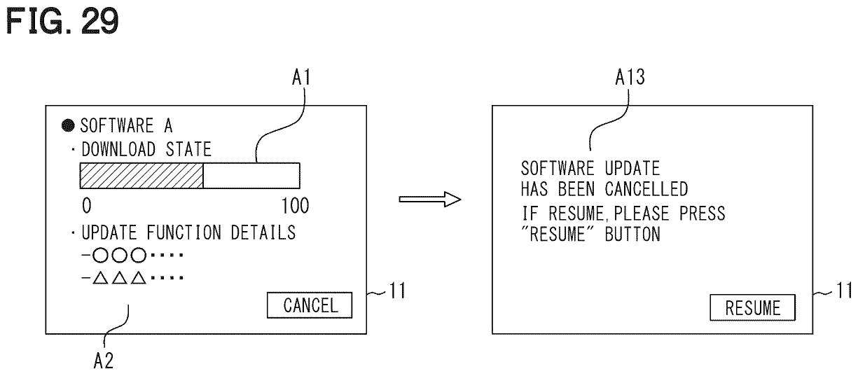

As shown in FIG. 29, when determining that the simple display of the update information is not in progress, the controller 16 determines the display mode of the update information based on the identification result of the occupant state, the identification result of the vehicle state, and the identification result of the operation input by the occupant. According to the determined display mode, the controller 16 causes the appropriate instrument to display the cancellation information indicating cancellation of the software update. The controller 16 displays a message A13 indicating that the software update has been stopped: “Software update has been cancelled. If resume, please press “Resume” button”.

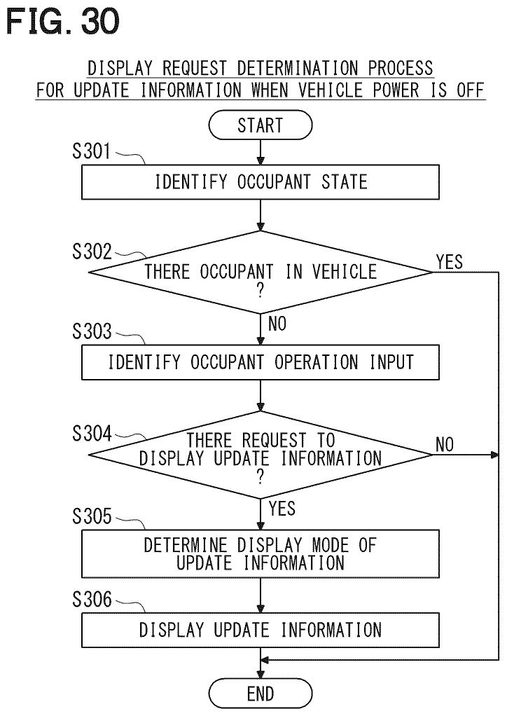

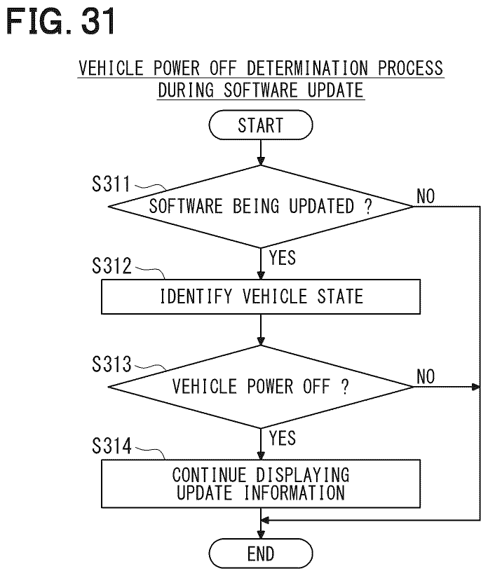

(3) Process for Displaying Update Information when Vehicle Power Source is Off (See FIGS. 30 and 31)

Here, the display request determination process for update information when the vehicle power source is off and the vehicle power source-off determination process during software update will be described in order.

(3-1) Display request determination process for update information when vehicle power source is off

The controller 16 periodically executes a display request determination process for the update information when the vehicle power source is off. When starting the update information display request determination process, the controller 16 identifies the occupant state based on the occupant state notification signal (S301), and determines whether the occupant is present in the vehicle (S302). When determining that the occupant is present in the vehicle (YES in S302), the controller 16 ends the display request determination process for the update information when the vehicle power source is off.

When determining that there is no occupant in the vehicle, i.e., that the occupant is absent (NO in S302), the controller 16 identifies the occupant's operation input based on the operation input detection signal (S303) and determines whether an operation input indicating the display request of update information has occurred (S304). When determining that no operation input indicating a display request for update information has occurred (NO in S304), the controller 16 ends the display request determination process for the update information when the vehicle power source is off.

The controller 16 determines that the operation input indicating the display result for the update information has occurred (YES in S304), and determines the display mode of the update information based on the identification result of the occupant state and the identification result of the operation input by the occupant (S305). The controller 16 causes the appropriate instrument to display the update information in accordance with the determined display mode (S306), and ends the display request determination process for the update information when the vehicle power source is off.

### (3-2) Vehicle Power Source-Off Determination Process During Software Update

The controller 16 executes a process of determining whether the vehicle power source is off during the software update at the predetermined interval. When starting the vehicle power source-off determination process during software update, the controller 16 determines whether the software is being updated (S311). When determining that the software is not being updated (NO in S311), the controller 16 ends the vehicle power source-off determination process during the software update.

When determining that the software is being updated (YES in 311), the controller 16 identifies the vehicle state based on the vehicle state notification signal (S312), and determines whether the vehicle power source is off (S313). When determining that the vehicle power source is not off (NO in S313), the controller 16 ends the vehicle power source-off determination process during the software update.

When determining that the vehicle power source is off (YES in S313), the controller 16 continues to display the update information (S314), and ends the vehicle power source-off determination process during the software update.

The above has exemplified the configuration in which the update information acquisition unit 16a, the occupant state identification unit 16b, the vehicle state identification unit 16c, the operation input identification unit 16d, and the display control unit 16e are arranged in the HCU 7, but the functions of each unit 16a to 16e may be distributed and arranged in separate devices. For example, an ECU for identifying the occupant state, an ECU for identifying the vehicle state, and an ECU for identifying the occupant's operation input may be separately arranged, and each of these ECUs may transmit the identification results to the HCU 7. Alternatively, the functions of the units 16a to 16e may be arranged in the CGW 5.

According to the present embodiment as described above, the following operation and effects can be obtained. In the HCU 7, when the operation input indicating the display request for update information is identified in a situation where it is identified that the vehicle power source is off and that there is no occupant in the vehicle, the display mode of the update information is determined more simply than when it is identified that the occupant is in the vehicle. The update information is displayed according to the determined display mode. By reducing the information amount and displaying the update information in the simple display mode, rather than increasing the information amount and displaying the update information in the detailed display mode, it is possible to appropriately display the update information regarding software update depending on the scene.

When an operation input is made to request display of update information when the vehicle power source is off and there are no occupants in the vehicle, the update information is displayed in the simpler display manner than when there are occupants in the vehicle. Thereby, it is possible to prevent unnecessary power consumption of the vehicle battery.

Notification of update information is performed by turning on, blinking, or turning off the indicator. The updated information can be displayed in the simple display manner by turning on, blinking, or turning off the indicator.

The update information can now be displayed from an external instrument outside the vehicle. The notification of the updated information can be provided to the occupant outside the vehicle.

When the state of the vehicle power source is identified as the off-state during the software update, the update information notification is continued. Even when the vehicle power source is off during software update, the notification of the update information is provided to the occupant.

The controller and the method thereof described in the present disclosure may be implemented by a dedicated computer configured by a processor and a memory programmed to execute one or more functions embodied by a computer program. Alternatively, the controller and the method thereof described in the present disclosure may be implemented by a dedicated computer configured by a processor including one or more dedicated hardware logic circuits. Alternatively, the controller and the method thereof described in the present disclosure may be implemented by one or more dedicated computers configured by a combination of a processor and a memory programmed to execute one or more functions and a processor configured by one or more hardware logic circuits. The computer program may be stored in a computer-readable non-transitory tangible storage medium as an instruction to be executed by the computer.

What is claimed is:

1. An update information notification device configured to cause a notification device to provide a notification of update information related to software update when software of an electronic control unit that is an update target is updated by update software acquired from a distribution device, the update information notification device comprising:
at least one of (i) a circuit and (ii) a processor with a memory storing computer program code executable by the processor, the at least one of the circuit and the processor configured to cause the update information notification device to:
acquire the update information;
identify an occupant state indicating a state of an occupant;
identify a vehicle state indicating a state of a vehicle;
identify an operation input by the occupant;
determine a notification mode of the update information and cause the notification device to provide the notification of the update information according to the determined notification mode; and
in a situation of having identified that a vehicle power source is off and identified that the occupant is not present in the vehicle, when identifying an operation input indicating a notification request of the update information, set the notification mode of the update information to a simpler display mode than when having identified that the occupant is present in the vehicle.

2. The update information notification device according to claim 1, wherein
the notification device includes an indicator, and
the at least one of the circuit and the processor is configured to cause the notification device to provide the notification of the update information by turning on, blinking, or turning off the indicator.

3. The update information notification device according to claim 1, wherein
the notification device includes an external instrument outside the vehicle, and
in the situation of having identified that the vehicle power source is off and identified that the occupant is not present in the vehicle, when identifying the operation input indicating the notification request of the update information, the at least one of the circuit and the processor causes the external instrument to provide the notification of the update information.

4. The update information notification device according to claim 1, wherein
the at least one of the circuit and the processor continues the notification of the update information when having identified that the vehicle power source is off during a software update.

5. A vehicle system comprising:
a notification device configured to provide a notification of update information related to software update when software of an electronic control unit that is an update target is updated by update software acquired from a distribution device; and
an update information notification device including at least one of (i) a circuit and (ii) a processor with a memory storing computer program code executable by the processor, the at least one of the circuit and the processor configured to cause the vehicle system to:
cause the notification device to provide the notification of the update information;
acquire the update information;
identify an occupant state indicating a state of an occupant;
identify a vehicle state indicating a state of a vehicle;
identify an operation input by the occupant;
determine a notification mode of the update information and cause the notification device to provide the notification of the update information according to the determined notification mode; and
in a situation of having identified that a vehicle power source is off and identified that the occupant is not present in the vehicle, when identifying an operation input indicating a notification request of the update information, set the notification mode of the update information to a simpler display mode than when having identified that the occupant is present in the vehicle.

6. A non-transitory computer-readable storage medium storing an update information notification program causing a controller of an update information notification device, which is configured to cause a notification device to provide a notification of update information related to software update when software of an electronic control unit that is an update target is updated by update software acquired from a distribution device, to:
acquire the update information;
identify an occupant state indicating a state of an occupant;
identify a vehicle state indicating a state of a vehicle;
identify an operation input by the occupant;
in a situation of having identified that a vehicle power source is off and identified that the occupant is not present in the vehicle, when identifying an operation input indicating a notification request of the update information, set a notification mode of the update information to a simpler display mode than when having identified that the occupant is present in the vehicle; and
cause the notification device to provide the notification of the update information according to the set notification mode.
